(19) United States
(12) Patent Application Publication
(10) Pub. No.: US 2023/0278059 A1
(43) Pub. Date: Sep. 7, 2023

(54) IN GROUND PROTECTION FOR A CYLINDRICAL SPRAY NOZZLE

(71) Applicant: Stephen D. Shoap, Wakefield, MA (US)

(72) Inventor: Stephen D. Shoap, Wakefield, MA (US)

(21) Appl. No.: 17/803,134

(22) Filed: Mar. 2, 2022

(51) Int. Cl. B05B 15/16; A62C 3/02

(52) U.S. Cl. CPC B05B 15/16; A62C 3/0292

(57) ABSTRACT

A cradle type structure is used to protect a cylindrical spray nozzle device from being crushed when both are buried in a trench in the ground. The cradle can be a three sided sheet of stainless steel that is open at the top. Brackets can connect the sides together for enhanced resistance to deformation. The top of the structure has a stainless steel lid that is hinged to the top of one of the sides. The lid protects the spray nozzle, but when the nozzle is spraying, the force of the water will push the lid up and out of the way of the spray.

### FIELD OF THE DISCLOSURE

The present disclosure is generally related to fluid spray systems for protecting structures from wildfires.

### BACKGROUND OF THE DISCLOSURE

Homes and other structures can suffer significant damage or destruction from wildfires. As discussed below, currently available systems designed to protect structures from wildfire damage are inadequate. One conventional method of stopping a grassfire or a wildfire is to create a fire break, a gap in vegetation or other combustible material that acts as a barrier to slow or stop the progress of a bushfire or wildfire. However, fires often create winds that blow embers through the air over long distances and across fire breaks. A fire break can be easily jumped by blowing embers, leaving structures vulnerable to ignition from these embers.

Within the industry, some conventional devices are available to help prevent blowing embers moving past a fire break. One such device, called a water curtain, uses a conventional hose that has many simple holes that are placed close together along the length of the hose. As water is pumped through the hose, it exits each hole and is directed straight up in a vertical column. The resulting overall spray shape is that of a thin curtain, in that, the spraying water is positioned along the length of the hose, but it is only a very thin wall of water. These water curtains are rarely used because they are too thin to significantly reduce radiant heat from a fire, and because the available water is better used to wet the nearby fuels to prevent their ignition.

One technique to protect a structure, such as a building, from a wildfire is to place permanent sprinklers on the roofs or walls of the structures. However, this equipment needs to be manually activated, which is problematic for situations in which evacuation has been ordered. If a homeowner happens to have a spray system available and starts the spray system before leaving, the water supply can quickly be depleted before the fire arrives. Water sprayed before the fire arrives can have some value in wetting the ground and walls of the home, but is not an efficient use of fluid. Thus, a heretofore unaddressed need exists in the industry to address the aforementioned deficiencies and inadequacies in current firefighting technologies.

### SUMMARY

The spray nozzle (Shoap U.S. Pat. No. 11,203,023)) can be used to protect a home or infrastructure from wildfire. The spray nozzle has two ends and a sidewall and at least one hole formed in the sidewall. The spray nozzle can be connected to adjacent spray nozzles by lengths of hose or other types of conduit. A hose with attached spray nozzles can be stored on a reel and deployed around the home when a wildfire is approaching.

In this patent application we propose that the spray nozzles and associated fluid transporting conduits can be buried underground in a trench. This will remove the need to deploy a hose with spray nozzles when a fire is approaching. However, the spray nozzle holes must be at ground level to allow for a full range of angles of spray. If the spray nozzles are to be connected by underground lengths of PVC pipe, the PVC pipe is typically buried 8 to 12 inches deep in the ground. A solution to this problem will be shown to be the use of PVC elbows to connect the spray nozzle and the PVC pipe that connects to it.

A hinged lid is attached to a three-sided structure which holds the spray nozzle. It is used to prevent dirt from clogging the holes in the top of the spray nozzle.

The lid is wider than the bottom of the cradle so that a closed lid will rest on top of the side opposite to the hinge. This will prevent the lid from damaging the cradle if a heavy vehicle presses down on the cradle and lid.

The spray nozzle is placed in the cradle so that the spray nozzle is protected from a vehicle weight when the hinged lid is flat on top of the spray nozzle. When the spray nozzle is spraying, the water pressure will force the hinged lid to fly open and out of the way of the spray.

### BRIEF DESCRIPTION OF DRAWINGS

FIG. 1 shows an oblique view of a cylindrical spray nozzle 110 and a three-sided cradle 100 that can protect the spray nozzle if it is to be buried in the ground. The cradle 100 can be stainless steel which can be buried in the ground without degradation. The cradle 100 can be formed by bending a flat piece of stainless steel so that the two sides are formed from the original flat sheet.

FIG. 2A is an oblique view that shows that stainless steel brackets 210 can be added to the cradle 100 to improve its resistance to deformation if a heavy vehicle drives over the cradle 100. The brackets 210 use the combined resistance of each side of the cradle 100 to resist deformation.

FIG. 2B is a top view of the spray nozzle 110 in the cradle 100 with the stainless steel brackets 210 on the ends.

FIG. 3A shows an oblique view of a hinged lid 310 on the cradle 100. The hinged lid prevents dirt and debris from getting into the holes in the spray nozzle.

FIG. 3B is an end view of the cradle 100 and spray nozzle 110 where the hinged lid 310 is almost flat. The hinged lid 310 overlaps the cradle 100 side opposite the hinged side. The overlap prevents the lid from crushing the spray nozzle 110 if a heavy vehicle drives over the cradle 100.

FIG. 4 shows a side view of PVC elbows 410 attached to PVC pipe 420 and that also attach to the spray nozzle 110. The elbows 410 allow the PVC pipe 420 supplying the water to the spray nozzle 110 to be deeper in the ground than the cradle 100 and spray nozzle 110.

### DETAILED DESCRIPTION

The present disclosure and figures are directed toward a cradle 100 device that will protect a spray nozzle 110 that has been buried in the ground.

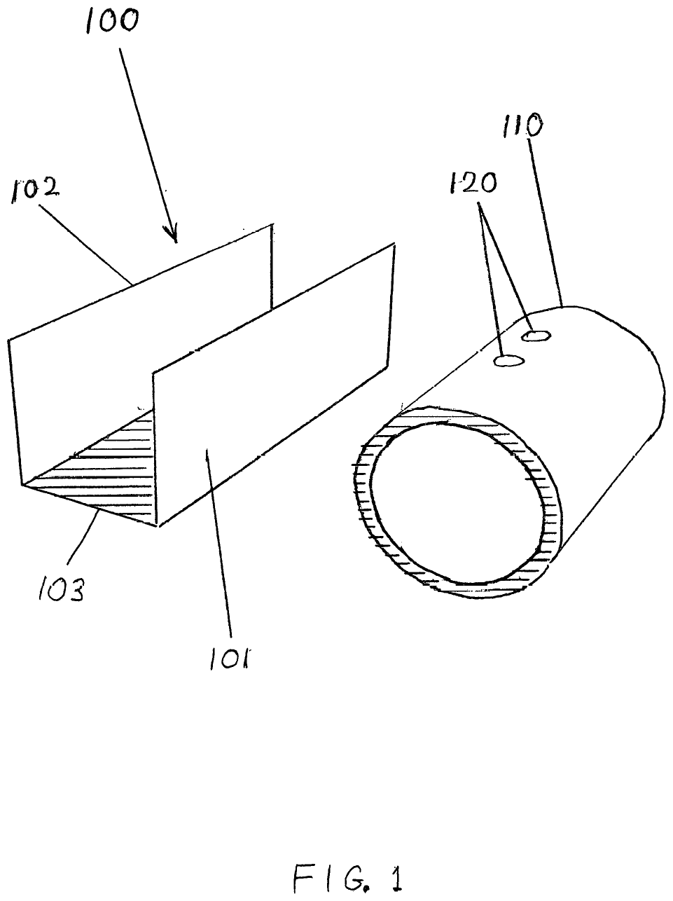

FIG. 1 shows a spray nozzle 110 with two spray holes 120.

It also shows the cradle 100 that spray nozzle 110 that will be placed inside. The cradle has a front wall 101 and a rear wall 102 and a bottom 103. Other materials can be used to form the cradle, but stainless steel is a good choice because of its strength and resistance to attack by the elements.

The cradle 100 cannot have a fixed top section because the spray must not be impeded. While other shapes are possible, the cradle 100 as described gives a desired amount of strength.

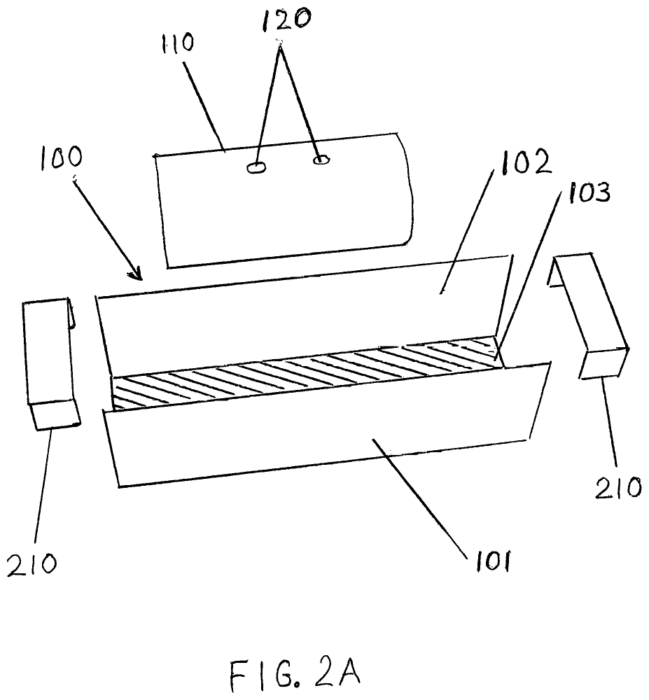

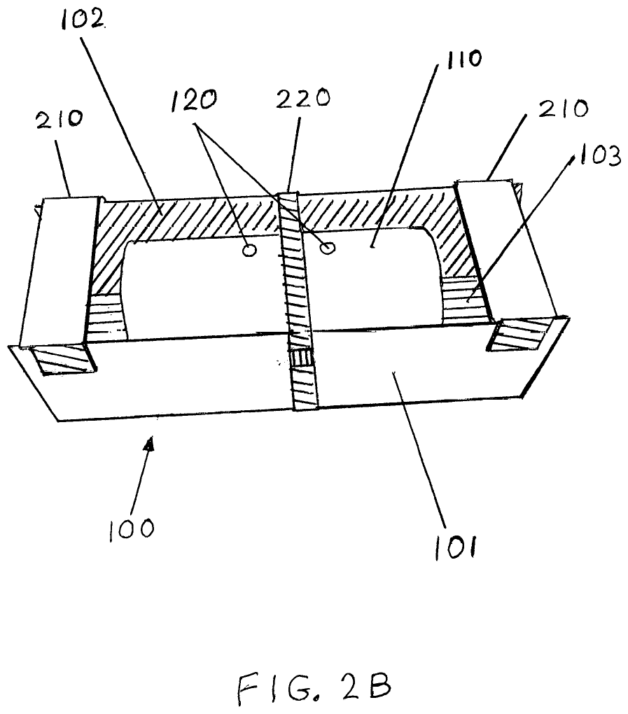

FIG. 2A shows the spray nozzle 110 above the cradle 100.

The holes 120 in the spray nozzle 100 are shown.

The two brackets 210 are shown near the ends of the cradle 100.

FIG. 2B shows a spray nozzle 110 inside of the cradle 100.

The brackets 210 are attached to the walls of the cradle 100 by welding, riveting, gluing or other bonding methods. The brackets 210 strengthen the cradle 100 by using the strength of both the front wall 101 and the rear wall 102 to resist deformation. A stainless steel zip tie 220 is shown pulling on the walls of the cradle and pushing on the top of the spray nozzle 110.

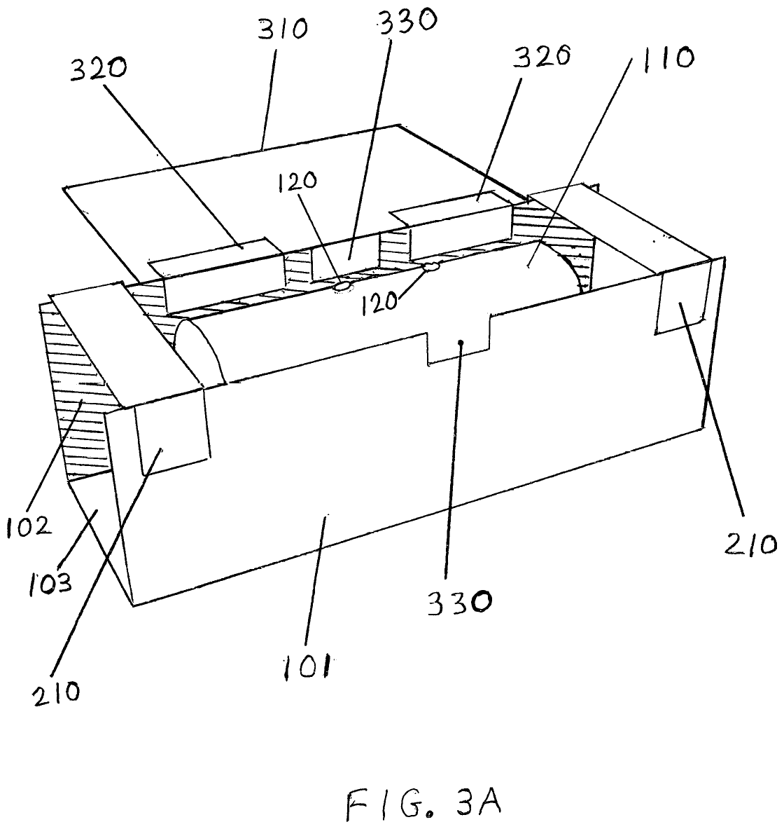

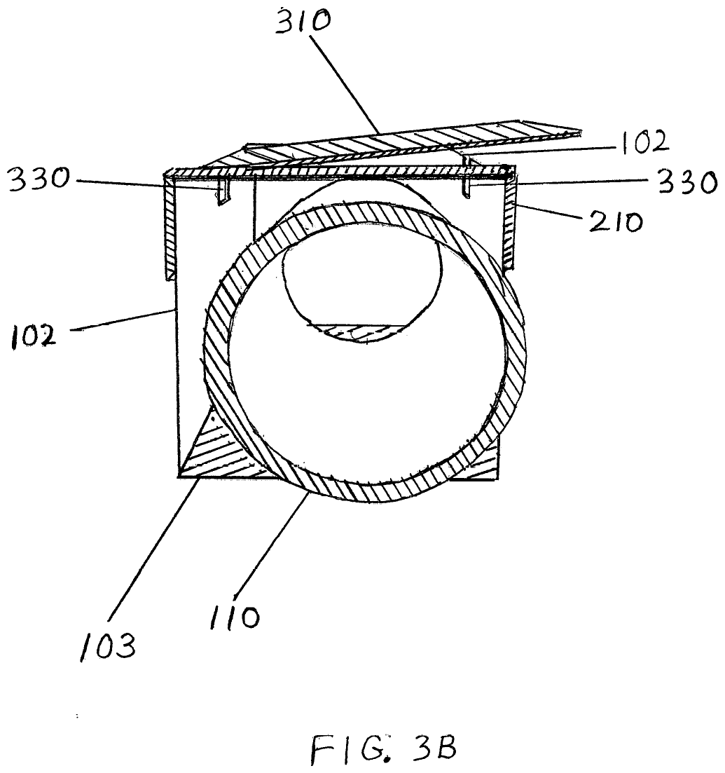

FIG. 3A shows notches 330 in the walls of cradle 100. The notches 330 insure that the zip tie 220 can press on the top of the spray nozzle 110.

It is important that the spray nozzle 110 can be placed in a desired angle inside the cradle. Different locations of a spray nozzle 110 may call for different directions to spray. The zip tie 220 with a moderate amount of tension will allow a spray nozzle 110 to be rotated in a cradle 100 by hand. When the spray nozzle 110 has been rotated into the desired angle, the zip tie 220 can be tightened as much as possible before the cradle 100 and spray nozzle 110 are buried in the ground. The excess metal on the zip tie can then be removed.

A stainless steel lid 310 is shown connected to the real wall 102 by hinges 320. The hinges 320 are attached to rear wall 102 and the lid 310 by welds, rivets, glue or other bonding methods. The lid 310 is opened when a spray nozzle 110 is going to be placed inside.

FIG. 3B shows an end view of the cradle 100 and the spray nozzle 110 inside. The lid 310 is almost closed. The lid is seen to extend well beyond the front wall 101. This is done to insure that if a heavy vehicle presses down on the lid 310, that the lid 310 will not be able to crush the spray nozzle 110, but will be stopped by the front wall 103.

A system pump takes water from a water tank or swimming pool or cistern and pumps the water through fluid transporting conduits to the nozzles. The force of the water coming out of each nozzle will flip the lid 310 upward and out of the way of the water spray.

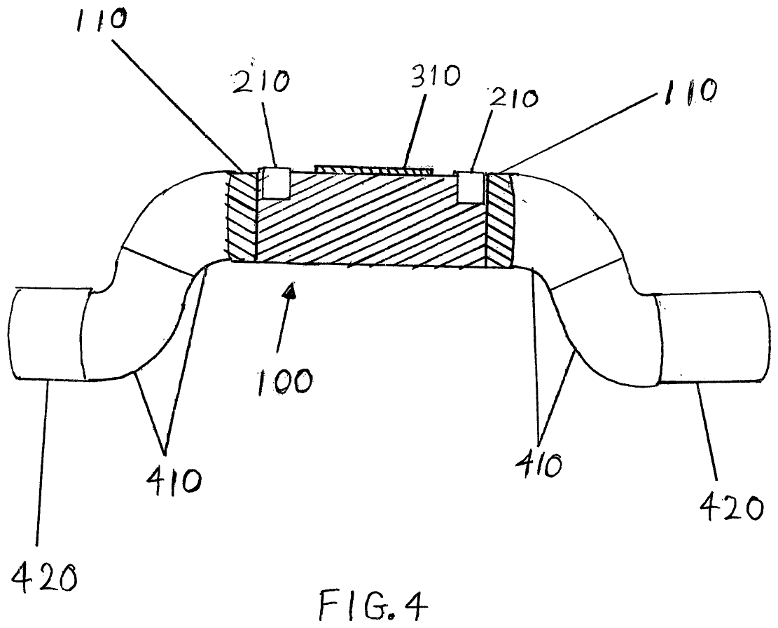

FIG. 4 shows how curved PVC pieces 410 can allow the cradle 100 to be placed at ground level, while the PVC pipes 420 that deliver the water to the spray nozzles 110 are place further underground for their protection.

The top of cradle 100 must be at ground level to insure that the possible angle of spray is maximized and not interfered with by walls of the ground they are buried in. The top of the cradle 100 should not be higher than the ground.

1. A device comprising:
a spray nozzle having two ends and a sidewall and at least one hole formed in the sidewall;
a cradle having a rectangular profile encasing the spray nozzle; and
a trench formed in the ground, wherein the cradle rests at least partially within the trench;

2. the device of claim 1, wherein
brackets connect and reinforce the opposing walls of the cradle.
